(19) United States
(12) Patent Application Publication
(10) Pub. No.: US 2006/0176324 A1
(43) Pub. Date: Aug. 10, 2006

(54) Display system having demand-based resolution and method therefor

(75) Inventor: Makoto Ono, Cary, NC (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/053,222

(22) Filed: Feb. 8, 2005

(51) Int. Cl. G09G 5/02

(52) U.S. Cl. 345/698

(57) ABSTRACT

A display system, method and apparatus having a demand-based resolution for displaying an image having a resolution greater than a predetermined resolution, in which a user computer has display hardware capable of generating a display signal. The display signal is of one of a low resolution display signal and a high resolution display signal corresponding to the resolution greater than the predetermined resolution. A display monitor is in electrical communication with the user computer. The display monitor has a usage manager that tracks an available quantity of high resolution display units and allows the display monitor to display one of a high resolution image and a low resolution image based on the available quantity of high resolution display units and the display signal.

### BACKGROUND OF THE INVENTION

1. Statement of the Technical Field

The present invention relates to graphical display devices such as computer displays and more particularly to display device having variable resolution capability whose resolution is set based on user demand and payment.

2. Description of the Related Art

As the processing and storage performance of computers has increase, so too has the technology and performance of computer display monitors. In the business environment, high resolution displays have been shown to increase productivity by increasing reading speed, increasing reading efficiency, speed up searching and editing tasks. However, unlike other peripheral devices such as the mouse, keyboard, that are used to interact with the central processing unit, high end computer display monitors with high resolution capabilities can cost as must or more than the computer itself. This is due, in significant part to the cost of the parts. As resolution capabilities and size increase, so too do the cost of parts such as the actual liquid crystal display (“LCD”), display microcontroller, etc.

As used herein, “high resolution” means a resolution generally greater than the normally expected resolution of a consumer grade monitor. For example, it is not uncommon to find computer displays with a resolution of up to 1600 pixels×1200 pixels. As such, high resolution in this context is greater than 1600 pixels×1200 pixels. As time goes by and display technology advances, it is contemplated that what will be considered “high resolution” will change.

Because high resolution displays are typically at the forefront of emerging technology and are costly relative to low resolution displays, a purchaser may hesitate to purchase the high resolution display unless there is some perceived guarantee of an enhancement in their productivity, i.e., a return on their investment. As such, even though a purchaser (user) may be more productive from the use of high resolution display, the cost of purchasing the display may dissuade the use of such a monitor.

Although a purchaser may determine the investment in a high resolution monitor is worth the cost, it is likely that not applications used require operation in a high resolution mode. Accordingly, despite the high cost of the investment, the display will not always require operation at the limits of its capability. This results in a decrease in the investment value.

It is therefore desirable to have a display capable of high resolution operation and supporting system components which tracks operation of the display when in a high resolution mode and implements a business model such that the cost of operation of the display is based on the use of the display in a high resolution mode.

### SUMMARY OF THE INVENTION

The present invention addresses the deficiencies of the art in respect to a high resolution display whose cost of use is based on the amount of time the display is operated in a high resolution mode. In this regard, the display tracks usage of the display in a high resolution mode. When pre-purchased high resolution display units have been consumed, the display will not operate in a high resolution mode. The system allows the units to be replenished through interaction with the user's computer and a server.

According to one aspect, the present invention provides a display system having a demand-based resolution for displaying an image having a resolution greater than a predetermined resolution, in which a user computer has display hardware capable of generating a display signal. The display signal is of one of a low resolution display signal and a high resolution display signal corresponding to the resolution greater than the predetermined resolution. A display monitor is in electrical communication with the user computer. The display monitor has a usage manager that tracks an available quantity of high resolution display units and allows the display monitor to display one of a high resolution image and a low resolution image based on the available quantity of high resolution display units and the display signal.

According to another aspect, the present invention provides a method for a display monitor providing a display resolution based on user demand and a quantity of available high resolution display units, a high display resolution having a resolution greater than a predetermined resolution, in which a display signal is generated. The display signal includes one of a high resolution and a low resolution display signal. The available quantity of high resolution display units is tracked. The display monitor is permitted to display one of a high resolution image and a low resolution image based on the available quantity of high resolution display units and the display signal.

According to still another aspect, the present invention provides a display monitor receiving a display signal corresponding to one of a low resolution image and a high resolution image having a resolution greater than a predetermined resolution, in which a display module displays one of the low resolution image and the high resolution image. A usage manager tracks an available quantity of high resolution display units. The usage manager allows the display module to display one of the high resolution image and the low resolution image based on the available quantity of high resolution display units and the display signal.

According to still yet another aspect, a machine readable storage device having stored thereon a computer program for providing a display resolution on a display monitor based on user demand and a quantity of available high resolution display units is provided. A high display resolution has a resolution greater than a predetermined resolution. The computer program includes a set of instructions which when executed by a machine causes the machine to perform a method in which a display signal is generated. The display signal includes one of a high resolution and a low resolution display signal. The available quantity of high resolution display units is tracked. The display monitor is permitted to display one of a high resolution image and a low resolution image based on the available quantity of high resolution display units and the display signal.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram of an exemplary system constructed in accordance with the principles of the present invention;

FIG. 2 is a block diagram of a computer and display monitor constructed in accordance with the principles of the present invention;

FIG. 3 is a block diagram of a server constructed in accordance with the principles of the present invention;

FIG. 4 is a flow chart of the display resolution management process of the present invention; and

FIG. 5 is a flow chart of the high resolution unit renewal process of the present invention.

### DETAILED DESCRIPTION OF THE PREFERRED EMBODIMENTS

The present invention advantageously provides a method, system and apparatus that provides a usage-based arrangement for a high resolution capable display. The present invention therefore provides a method, system and apparatus that allows a business model to be implemented that allows a purchaser to pay for a high resolution display only for the period needed, with the display monitor being available the remainder of the time to provide a low resolution display. The model described herein tracks usage of the display in the high resolution mode and allows a purchaser to renew high resolution display mode time (units).

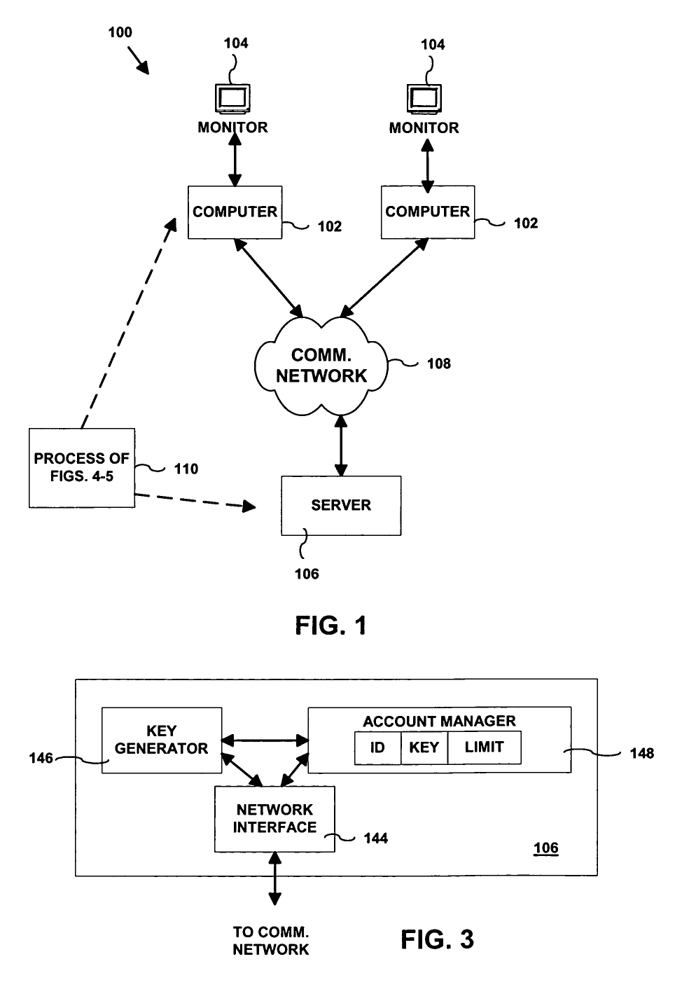

Referring now to the drawing figures in which like reference designators refer to like elements, there is shown in FIG. 1 a system constructed in accordance with the principles of the present invention and designated generally as “100”. System 100 includes a computer 102 to which is coupled monitor 104. Computer 102 communicates with server 106 via communication network 108. Communication network 108 can be any network capable of transporting data between computer 102 and server 106 such as the Internet or another transmission control protocol/internet protocol (“TCP/IP”) network.

Computer 102, described in detail below, can be a personal computer, mini-computer or mainframe computer or any other computing device capable of supporting the hardware and functionality described herein, and in particular, with the ability to support a high resolution display monitor. Monitor 104 is a display monitor capable of generating a high resolution display (as that term is used and defined herein) as well as incorporate the hardware and software functions described in detail below. Server 106 is arranged to communicate with computer 102 via communication network 108 and is further arranged to support the functions described herein with respect to the present invention.

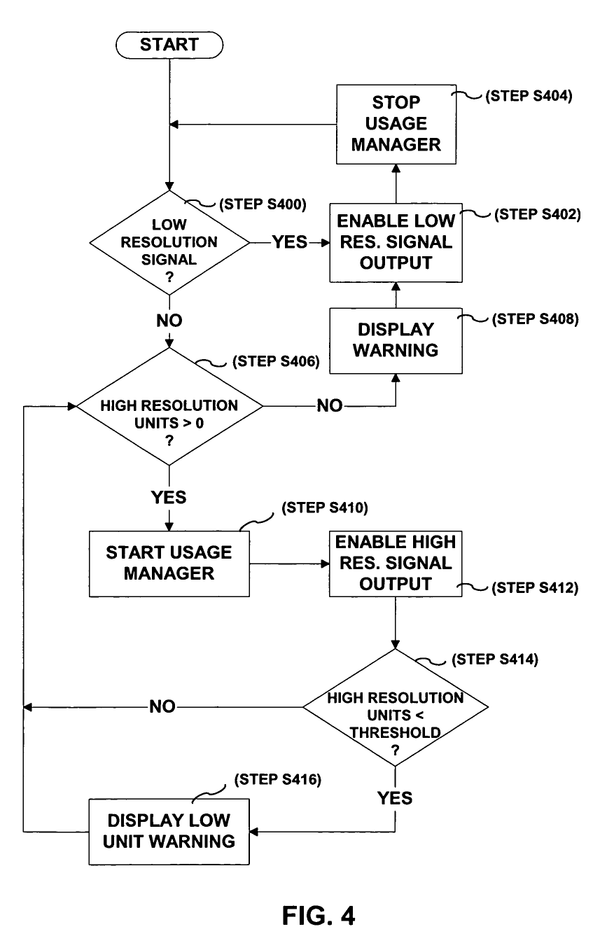

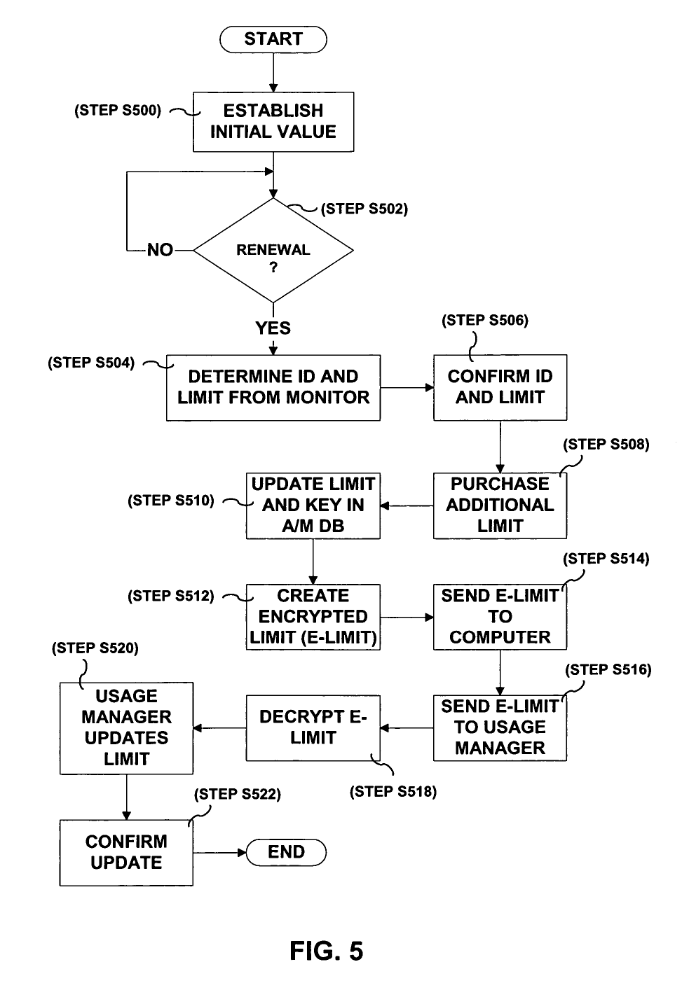

Resolution management process 10 is performed by user computer 102, monitor 104 and server 106. This process is described below in detail with reference to FIGS. 4-5.

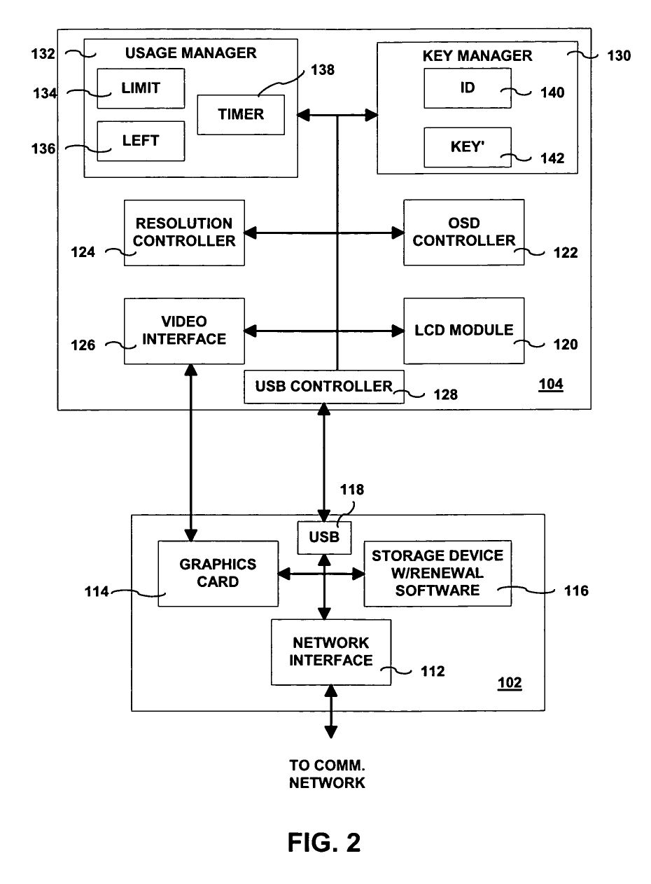

User computer 102 and monitor 104 are described in detail with reference to FIG. 2. In addition to those components typically included as part of a user computer as is known in the art, including but not limited to a central processing unit (“CPU”), volatile and non-volatile memory, etc. (not shown), user computer 102 includes network interface 12, graphics card 14, a storage device with renewal software 116 and USB interface 118. Network interface 12 can be any interface suitable for facilitating communication with communication network 108 such as an Ethernet controller for wired or wireless communication.

Graphics card 114 can be any graphics card, such as a digital video interface (“DVI”) card, capable of generating a low resolution display signal and a high resolution display signal having a resolution above a predetermined threshold. Storage device 116 can be any storage device such as flash memory, a hard drive, random access memory (“RAM”), and the like, suitable for storing programmatic software such as the high resolution display unit renewal software described in detail below. Briefly, the high resolution display unit renewal software facilitates communication between monitor 104 and server 106 to allow a user to purchaser additional high resolution display units to allow the monitor 104 to continue to be operable in a high resolution mode.

USB interface 118 can be any USB interface suitable for communicating with display monitor 104. For example, it is not uncommon for state of the art display monitors to incorporate a USB hub therein. In addition, although the present invention is explained with reference to USB communications between the computer 102 and monitor 104, the invention is not so limited. It is contemplated that any method of data communication between computer 102 and monitor 104 can be used.

Monitor 104 includes LCD module 120, on screen display (“OSD”) controller 122, resolution controller 124, video interface 126, USB controller 128, key manager 130 and usage manager 132. Although not shown, it is contemplated that these elements can be controlled by a microcontroller and communicate via an internal bus. In addition, although shown as separate elements, it is contemplated that one or more of these elements can be combined into a single integrated circuit and/or be software-based.

LCD module 120 can be any display module capable of displaying low and high resolution images thereon for viewing by the user. Although display module 120 is described as an LCD module, the invention is not so limited. Other technologies, such as plasma displays, traditional cathode ray tubes (“CRT”) can be used and fall within the spirit of the present invention.

OSD controller 122 is arranged to provide textual and/or graphical information to a user, typically by superimposition over the underlying display, on LCD module 120. Traditionally, an on-screen display controller would be used to display a menu and setup functions for interaction by the user of the display to allow for device configuration. In accordance with the present invention, OSD controller 122 is further used to provide feedback to the user regarding the quantity of high resolution display units available, remaining, etc. and to facilitate the renewal process in the case where the user wishes to purchase additional high resolution display units. As is described below in more detail, the present invention is arranged such that display monitor 104 will operate to display a high resolution image thereon if there are high resolution display units available. As the monitor is operated in a high resolution mode, high resolution data units are decremented. When no high resolution data units are available, display monitor 104 will not operate in a high resolution mode.

Resolution controller 124 operates in connection with usage manager 132 and video interface 126 to control the resolution of the image display on LCD module 120. For example, if usage manager 132 instructs resolution controller 124 to only display a low resolution image on LCD module 120, resolution controller 124 will generate an appropriate signal to only display a low resolution image.

Video interface 126 is arranged to receive a display signal from graphics card 114 in user computer 102 and generate appropriate drive signals to cause an image to be displayed on LCD module 120. In the alternative, video interface 126 can merely receive the display signal, process it, and transfer to the processed signal to resolution controller 124, which in turn generates the signal to drive module 120. As noted above, resolution controller 124 receives data from usage manager 132 corresponding to the permitted display resolution, and generates a corresponding signal to drive LCD display unit 120. USB controller 128 is arranged to provide bidirectional communication between monitor 104 and user computer 102 using a USB protocol. As discussed above, any suitable data communication technology can be used.

Display monitors constructed in accordance with the principles of the present invention also include usage manager 132. Usage manager 132 tracks the quantity of available high resolution display units and provides instructions to resolution controller 124 as to whether a high resolution image should be displayed on LCD module 120, assuming video interface 126 received a high resolution display signal from graphics card 114. Usage manager 132 tracks the upper limit of the number of high resolution display units available as limit 134 and tracks the number of high resolution display units left to use 136. Usage manager 132 also includes a timer 138 which decrements the quantity of high resolution display units left during the time that video interface 126 receives a high resolution display signal. High resolution display units can take the form of any suitable unit, for example minutes or hours, and timer 138 can be arranged to decrement these units each minute or hour as the case may be.

Key manager 130 includes ID 140 uniquely assigned to each monitor 104 as well as a public key 142. As is discussed below in detail, key manager 130 facilitates the renewal and purchase of additional high resolution display units to renew limit 134.

Server 106 is explained in detail with reference to FIG. 3. In addition to the elements typical to a server, such as an operating system, central processing unit, memory, input/output peripheral devices, etc. (not shown), server 106 constructed in accordance with the principles of the present invention includes network interface 144, key generator 146 and account manager 148. As discussed above with respect to network interface 112 in user computer 102, network interface 144 can be any interface suitable for facilitating communications with communication network 108.

Key generator 146 is arranged to generate and encrypt information used to renew the available quantity of high resolution display units for a monitor 104. Account manager 148 can be a database, file, or any other means for tracking the upper limit of high resolution display units for a monitor having a corresponding identification string, as well as a key generated by key generator 146. As described below in detail, when a user purchases an additional quantity of high resolution display units to renew the available quantity of such units to the original (or new) limit, an entry is made by account manager 148 of its limit, the assigned encryption key as well as the identification string for the corresponding monitor 104.

The resolution management process of the present invention is described with reference to FIG. 4. Initially, when a display signal is received by video interface 126, resolution controller 124 evaluates the display signal to determine whether the signal is a low resolution signal (Step S400). If the signal is a low resolution signal, resolution controller 124 enables a low resolution output signal (Step S402) for display on LCD module 120, and stops usage manager 132 from decrementing the high resolution display unit quantity (Step S404). If the received display signal is not a low resolution signal (indicating that the display signal is a high resolution signal), i.e., a signal having a resolution greater than a predetermined resolution, resolution controller 124 communicates with usage manager 132 to determine whether high resolution display units are available, i.e., greater than 0 (Step S406). If high resolution display units are not available, usage manager 132 instructs OSD controller 122 to display a suitable warning on LCD module 120 (Step S408) and the resolution controller 124 enables only a low resolution signal output (Step S402). In the alternative, if no high resolution display units are available, OSD controller can be instructed to generate and cause the display of a warning as in Step S408, with the LCD module 120 being otherwise blank, i.e., a low resolution image is not displayed at all.

If high resolution display units are available (Step S406), resolution controller 124 instructs usage manager 132 to start the timer 138 to begin decrementing the available quantity of high resolution display units at the predetermined rate (Step S410). Resolution controller 124 enables the high resolution display signal to be output on LCD module 120 (Step S412) so the user can view the high resolution image.

In addition, because usage manager 132 tracks the quantity of available high resolution data units, if the quantity of available high resolution units is greater than 0 but below a predetermined warning threshold (Step S414), usage manager 132 can instruct OSD controller 122 to display a low unit warning (Step S416) on the display screen so that the user is aware that the quantity of available high resolution data units is approaching 0, thereby allowing the user the opportunity to purchase additional high resolution display units.

The high resolution display unit renewal process of the present invention is described with reference to FIG. 5. When a display monitor is manufactured, an initial high resolution display unit value can be established in usage manager 132 (Step S500). A corresponding entry is typically made in account manager 148 so that they provider of the high resolution display monitor and system likewise knows the initial high resolution display unit quantity and can refer to this quantity for future renewals and authentication. In the alternative, it is contemplated that the monitor can be manufactured and shipped with no high resolution display unit quantity available such that the user much purchase such units in order for the display monitor 104 to be operable in a high resolution display mode.

Regardless, during the course of operation it is likely that the user will want to use the monitor for display of a high resolution image and will either need to purchase initial units (not shown) or renew the quantity of high resolution display units (Step S502). It should be understood that the process for renewing high resolution display units is the same as if display monitor 104 was shipped with no available high resolution display units and such units are initially purchased.

When renewal of the high resolution display unit limit is required, the user launches the renewal software on the user computer. The renewal limit software determines the ID string as well as the high resolution display unit limit 134 from monitor 104 via USB interface 118 (Step S504). Renewal software 116 communicates with server 106, in particular account manager 148, and confirms the identification string and limit received from monitor 104 are the same as in the account manager database (Step S506). Once confirmed, it is known which specific monitor is being updated. In addition, by confirming the ID and original limit, server 106 can gain some assurance that it is not being spoofed and also that it will not erroneously be updating a different monitor.

Once confirmed, the user is invited to purchase an additional limit (Step S508). Methods for receiving payment via a communication network are known and are beyond the scope of the subject invention. Once purchased, account manager 148 updates the limit to create a new limit based on the current quantity of units left in display monitor 104 plus the newly purchased units and generates a key in the account manager 148 database (Step S510). Key generator 146 encrypts the new limit to create an “E-limit” (Step S512). For example, key generator 146 can use the key as a public encryption key and generate the E-limit, which it passes back to account manager 148. The E-limit is sent by server 106 to user PC 102 via communication network 108 (Step S514) which in turn passes the E-limit to usage manager 132 (Step S516).

Key manager 130 generates a new limit by decrypting the E-limit using key 142 (Step S518). If the decryption is successful, usage manager 132 updates limit 134 with the new limit (Step S520) and resets the quantity left 136 to equal the new limit 134. Monitor 104, via USB controller 128, alerts renewal software 116 that the limit has been updated and renewal software 116 confirms the same with account manager 148 (Step S522).

It is also contemplated that a user may operate the display monitor in a high resolution mode so frequently as to create the need for repeated purchases of additional high resolution display units. As such, usage manager 132 and/or account manager 148 can include an upper ceiling value that, if a total quantity of high resolution display units purchased for a particular monitor 104 reaches that value, account manager 148 provides a special key so that the customer can use the monitor in the high resolution display mode forever without the need to purchase any additional units. In the alternative, instead of providing a special key, usage manager 132 can likewise be triggered to allow unhindered operation in the high resolution display mode.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

I claim:

1. A display system having a demand-based resolution for displaying an image having a resolution greater than a predetermined resolution, the system comprising:
a user computer having display hardware capable of generating a display signal, the display signal comprised of one of a low resolution display signal and a high resolution display signal corresponding to the resolution greater than a predetermined resolution; and
a display monitor in electrical communication with the user computer, the display monitor having a usage manager that tracks an available quantity of high resolution display units, the usage manager allowing the display monitor to display one of a high resolution image and a low resolution image based on the available quantity of high resolution display units and the display signal.

2. The display system according to claim 1, wherein the usage manager will only allow display of a low resolution image regardless of the display signal if the available quantity of high resolution display units falls below a predetermined threshold.

3. The display system according to claim 1, wherein the user computer further includes a storage unit storing high resolution renewal software for facilitating the renewal of high resolution display units.

4. The display system according to claim 3, further including a server in communication with the user computer, the server including an account manager, the account manager storing an identification code for the display monitor, an encryption key corresponding to the display monitor and a high resolution display unit limit corresponding to the display monitor, the server being interoperable with the display monitor and the renewal software to allow a user to replenish the available quantity of high resolution display units.

5. The display system according to claim 4, wherein the replenished quantity of high resolution display units is stored by the account manager and wherein the renewal software updates the quantity of high resolution display units in the display monitor usage manager.

6. The display system according to claim 5, wherein the server further includes an encryption key generator and the display monitor further includes a key manager, wherein to replenish the quantity of available high resolution display units, the server uses the encryption key generator to generate a new encrypted high resolution display unit limit for transmission to the display monitor, the key manager decrypting the new encrypted high resolution display unit limit, the new high resolution display unit limit being provided to the account manager.

7. A method for a display monitor providing a display resolution based on user demand and a quantity of available high resolution display units, a high display resolution having a resolution greater than a predetermined resolution, the method comprising:
generating a display signal, the display signal comprised of one of a high resolution and a low resolution display signal; and
tracking the available quantity of high resolution display units; and
allowing the display monitor to display one of a high resolution image and a low resolution image based on the available quantity of high resolution display units and the display signal.

8. The method according to claim 7, wherein a low resolution image will be displayed regardless of the display signal if the available quantity of high resolution display units falls below a predetermined threshold.

9. The method according to claim 7, further including storing high resolution renewal software for facilitating the renewal of high resolution display units.

10. The method according to claim 9, further comprising:
notifying a user that the quantity of available units has fallen below a second predetermined threshold; and
allowing a user to replenish the available quantity of high resolution display units.

11. The method according to claim 10, further including storing an identification code for the display monitor, an encryption key corresponding to the display monitor and a high resolution display unit limit corresponding to the display monitor in a server.

12. The method according to claim 11, wherein allowing a user to replenish the available quantity of high resolution display units includes:
obtaining a replenished quantity of high resolution display units;
storing the replenished quantity of high resolution display units is stored by the server; and
updating the quantity of high resolution display units in the display monitor.

13. The method according to claim 12, wherein obtaining a replenished quantity of high resolution display units includes:
generating a new encrypted high resolution display unit limit;
transferring the new encrypted high resolution display unit limit to the display monitor; and
decrypting the new encrypted high resolution display unit limit.

14. A display monitor receiving a display signal corresponding to one of a low resolution image and a high resolution image having a resolution greater than a predetermined resolution, the display monitor comprising:
a display module for displaying one of the low resolution image and the high resolution image; and
a usage manager that tracks an available quantity of high resolution display units, the usage manager allowing the display module to display one of the high resolution image and the low resolution image based on the available quantity of high resolution display units and the display signal.

15. The display monitor according to claim 14, wherein the usage manager is arranged to only allow the display module to display a low resolution image regardless of the received display signal if the available quantity of high resolution display units falls below a first predetermined threshold.

16. The display monitor according to claim 14, further including an on screen display controller, wherein the usage manager notifies the on screen display controller to alert a user of a low available high resolution display unit balance if the quantity of available high resolution display units falls below a second predetermined threshold.

17. The display monitor according to claim 15, wherein the usage manager includes a timer, the timer decrementing the available quantity of high resolution display units at a predetermined rate when the received display signal corresponds to a high resolution image.

18. The display monitor according to claim 14, further comprising a key manager, the key manager receiving an encrypted new high resolution display unit limit if a user purchases additional high resolution display units.

19. The display monitor according to claim 18, wherein the key manager includes an identification code corresponding to the display monitor and a key, the key manager using the key and the identification code to decrypt the encrypted new high resolution display unit limit.

20. The display monitor according to claim 15, further including a resolution controller in electrical communication with the display unit and the usage manager, the resolution controller receiving data from the usage manager corresponding to the display resolution, and generating a corresponding signal to drive the display unit.

21. A machine readable storage device having stored thereon a computer program for providing a display resolution on a display monitor based on user demand and a quantity of available high resolution display units, a high display resolution having a resolution greater than a predetermined resolution, the computer program comprising a set of instructions which when executed by a machine causes the machine to perform a method including:
generating a display signal, the display signal comprised of one of a high resolution and a low resolution display signal; and
tracking the available quantity of high resolution display units; and
allowing the display monitor to display one of a high resolution image and a low resolution image based on the available quantity of high resolution display units and the display signal.

22. The method according to claim 21, wherein a low resolution image will be displayed regardless of the display signal if the available quantity of high resolution display units falls below a predetermined threshold.

23. The method according to claim 21, further including storing high resolution renewal software for facilitating the renewal of high resolution display units.

24. The method according to claim 23, further comprising:
notifying a user that the quantity of available units has fallen below a second predetermined threshold; and
allowing a user to replenish the available quantity of high resolution display units.

25. The method according to claim 24, further including storing an identification code for the display monitor, an encryption key corresponding to the display monitor and a high resolution display unit limit corresponding to the display monitor in a server.

26. The method according to claim 25, wherein allowing a user to replenish the available quantity of high resolution display units includes:
obtaining a replenished quantity of high resolution display units;
storing the replenished quantity of high resolution display units is stored by the server; and
updating the quantity of high resolution display units in the display monitor.

27. The method according to claim 26, wherein obtaining a replenished quantity of high resolution display units includes:
generating a new encrypted high resolution display unit limit;
transferring the new encrypted high resolution display unit limit to the display monitor; and
decrypting the new encrypted high resolution display unit limit.
